(19) United States
(12) Patent Application Publication
(10) Pub. No.: US 2010/0183160 A1
(43) Pub. Date: Jul. 22, 2010

(54) VIBRATION SENSOR ASSEMBLY WITH AMBIENT NOISE DETECTION

(76) Inventors: Michael Charles Cosgrove, Hamilton (NZ); Daniel Brett Rosborough, Hamilton (NZ); Jonathan Brereton Scott, Ohaugo (NZ)

Correspondence Address: GREER, BURNS & CRAIN, 300 S WACKER DR, 25TH FLOOR, CHICAGO, IL, 60606, US

(21) Appl. No.: 12/532,356

(22) PCT Filed: Mar. 20, 2008
(86) PCT No.: PCT/NZ08/00064

§ 371 Date: Mar. 25, 2010

(30) Foreign Application Priority Data
Mar. 21, 2007 (NZ) 554060

(51) Int. Cl. H04R 29/00

(52) U.S. Cl. 381/58

(57) ABSTRACT

A sensor assembly for detecting vibrational energy on a target surface, including at least one target vibration transducer configured to measure vibrational energy associated with at least one target surface; and at least one environmental vibration transducer, each environmental vibration transducer being configured to measure vibrational energy in the immediate vicinity of the environmental vibration transducer wherein the environmental vibration transducer is vibrationally isolated from the target vibration transducer.

### TECHNICAL FIELD

The present invention relates generally to sensors, and in particular to a sensor assembly for detecting vibrational energy on a surface.

### BACKGROUND ART

There are many types of sensors which may be configured to detect unauthorised entry or tampering with a building or vehicle. Typically these sensors are attached to some type of alarm which may sound on detection of an intruder.

For example, sensors may be placed inside a building and set when there is expected to be no movement within the building. However, such movement sensors are not suitable for buildings containing something which moves inside the building, such as a household pet or other animal. Movement sensors are also not suitable for alarming the building when someone is inside the building.

To overcome the deficiencies of movement sensors, there are a number of “tamper detectors” available. These detectors detect loud noises, for example such as made by a glass window breaking, which may indicate that a person is forcing their way into a building. These detectors generally aim to detect someone entering the building through breaking a window or door (or tampering with some other structural surface) by detecting noise in the area where they are mounted.

A loud noise can indicate that the surface on which the detector is mounted has probably been tampered with. Noise detection can be made by use of a microphone which detects the passage of significant energy which will then set off an alarm system, generally if the amount of noise exceeds a preset threshold.

Systems that use acoustic threshold detector technology with signal processing capability generally require considerable signal processing power to process the complex signals and then to determine whether a specific noise crosses an alarm trigger threshold. Even such complex detectors, when mounted in noisy areas, sometimes have a low sensitivity set to overcome general ambient noise. A deficiency with these detectors is that loud ambient noises that are not related to tampering can set off alarms. False alarms are highly undesirable, causing inconvenience to the building users, owners and surrounding sites.

In attempts to overcome the above deficiencies, detectors have been developed which assess the frequency spectrum of any noise detected and relate that frequency to a known frequency spectrum for a set event, such as breaking glass. For example, if the signal of the detected noise corresponds to that known for breaking glass, then an alarm may sound. However, this type of detector is quite complicated, and high frequency noises in the same band which are not the result of broken glass may still trigger the alarm. These detectors also cannot be arranged to detect other sounds, such as doors being forced open.

It would be preferable to have an alarm which does not require complex, and therefore expensive, signal frequency processing to determine whether forced entry to a building has occurred. It would be preferable to have a sensor which may be fixed to a number of different surfaces. It would also be preferable to have a sensor which is resistant to ambient noise causing false positive alarm triggers. In short, a low-cost sensor with a low false-alarm rate is needed.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only.

### SUMMARY OF THE INVENTION

According to one aspect of the present invention there is provided a sensor assembly for detecting vibrational energy on a target surface, including
at least one target vibration transducer configured to detect vibrational energy associated with at least one target surface; and
at least one environmental vibration transducer, each environmental vibration transducer being configured to detect vibrational energy in the immediate vicinity of the environmental vibration transducer
   wherein the at least one environmental vibration transducer is vibrationally isolated from the at least one target vibration transducer.

Reference throughout the specification will be made to a sensor assembly being used to detect vibration on a surface caused by an intruder attempting to enter a building. However, those skilled in the art should realise that other applications for the present invention are envisaged and that reference to the above only throughout this specification should in no way be seen as limiting.

Reference throughout this specification to vibrational energy associated with a surface (or object) should be understood to refer to the energy of a vibration on the surface (or in the object).

In a preferred embodiment the vibrational energy is audio energy.

Audio energy should be understood to be that related to a vibration having a frequency in the audio frequency band. Reference throughout this specification will be made to energy in the form of audio energy. However, those skilled in the art will appreciate that other forms of energy, such as (without limitation) as associated with ultrasonic and infrasonic vibrations, may be used and that reference to audio energy only should not be seen as limiting.

An advantage of using audio (or acoustic) vibrations is that tampering with a surface, such as breaking a window or door, typically produces audible sounds that are associated with vibration of the surface.

In the preferred embodiment each of the target and environmental vibration transducers is an audio transducer.

Audio transducers are commonly available and inexpensive, and so do not add significantly to the manufacturing cost of the sensor assembly.

Reference throughout this specification to an object being vibrationally isolated from another object should be understood to mean that the vibration energy detected at one object is not transferred directly from that object to the other, but must pass through a medium where the vibration energy is attenuated.

In a preferred embodiment the sensor assembly includes

at least two mounts, wherein
the at least one target transducer is attached to a first mount configured to vibratrionally couple to a target surface, and
the at least one environmental transducer is attached to a second mount
wherein the second mount is vibrationally isolated from the first mounting means.

Reference to two objects being vibrationally coupled should be understood to mean that vibrational energy can be transferred from one object to the other with relatively low attenuation. In other words there is good vibrational contact between the two objects.

Preferably the target surface may be a surface of a structure, such as (without limitation) a window, window frame, door, or roof of a building, or a barrier such as a fence.

In alternative embodiments, the target surface may be any other solid surface, such as windows of vehicles that may be tampered with or vandalised.

Vibrational isolation between the first and second mounts may be achieved by physically separating the first and second mounts from each other so that vibration in one mount is not readily transferred to the other.

For example, the first mount may be located on a target window so that a target audio transducer attached to the first mount is acoustically coupled to the target surface. The second mount may be away from the window, so that sound originating at the window (due to tampering) will predominantly travel to the second mount (to which the environmental transducer is attached) through air. Sound travelling through air is a relatively highly attenuated so that the energy detected at the environmental audio transducer may be considerably less than that detected at the target audio transducer for the same event.

In a preferred embodiment the mounts are configured such that the first mount and at least the second mount are physically connected.

An advantage of this embodiment is that at least one environmental transducer and at least one target transducer may be provided in the same physical unit.

The first mount may be physically connected to the second mount in a manner that severely limits the transfer of vibrational energy between the first and second mounts.

In some embodiments this may be achieved through the use of a material which physically “suspends” the second mount on the first mount while acoustically isolating them.

Suitable materials for this use may be felt, synthetic sponge or acoustic foam, among others. However, any material that has a high acoustic impedance, making it difficult to propagate sound waves through it, may be used

In other embodiments the connection between the first and second mounting means may be a spring, particularly a spring with relatively low stiffness (low spring constant)

The audio energy measured by a target audio transducer may be energy from the environment impacting and then propagating along the target surface, such as ambient noise causing the target to vibrate, or may be energy generated within the target only, such as may occur when a target surface is broken or otherwise tampered with.

An environmental transducer is preferably configured to measure acoustic energy in the immediate surrounding of the transducer, but not directly associated with the target. The amount of energy detected by the target transducer may be compared with that detected at the environmental transducer for the same event to determine whether the predominant energy source is likely to be in the environment or in the target surface.

In a preferred embodiment the sensor assembly includes a processor for receiving signals indicating energies from the target transducer and the environmental transducer, for comparing energy from the target audio transducer with energy from the environmental transducer, and for outputting a signal based upon the comparison.

According to a further aspect of the present invention there is provided computer executable instructions, including the steps of:
a) receiving energy from at least one target transducer configured to measure energy associated with at least one target surface;
b) receiving energy from at least one environmental transducer, each environmental transducer being configured to measure energy in the immediate surroundings of the environmental transducer;
c) comparing the energy from the target transducer with the energy from the environmental transducer; and
d) outputting a signal based upon the comparison;
   wherein the environmental transducer is vibrationally isolated from the target transducer.

Preferably, the audio energies received from an environmental transducer and a target transducer may be compared to determine whether an alarm condition is met. If the output signal based on the comparison exceeds a preset threshold then an alarm may be activated.

In a preferred embodiment the comparison is made by determining a ratio of the audio energy from the at least one target audio transducer and the at least one environmental audio transducer.

In a preferred embodiment, the comparison is a ratio of time-averaged means of the absolute values of bandpass-filtered voltages from the at least one target audio transducers and the at least one environmental audio transducer.

This comparison method takes advantage of the fact that the output voltages of each transducer are representative of the sound pressure level of the vibrations received by each of the transducers. Using a time averaged mean of the absolute values of the output voltages, where the frequency components are exponentially weighted, results in a single value for each transducer, the value being representative of the total amount of vibrational energy received during the time period. Thus a simple comparison may be made by forming the ratio of the single value for a target transducer with that for an environmental transducer.

An advantage of this method is that the processing is relatively simple, and avoids the more complex processing required by some prior art devices which use spectral comparisons. As a result the comparison for the present invention may be carried out quickly on a relatively inexpensive microprocessor, saving time and cost.

However, in alternative embodiments the signals may be compared by means other than by a ratio, such as making an absolute value subtraction of the audio energy received from a target transducer and an environmental transducer. In this instance, if the difference exceeds a preset threshold value, then an alarm may be activated.

Preferably the sensor assembly of the present invention may include at least one processing element. This processing element may preferably be a microprocessor, configured to receive signals from the transducers and to compare same. Having the processing carried out by a processor in the sensor assembly may provide the advantage of a self-contained, tamper-proof unit.

In some other embodiments the output from the transducers may be processed separately from the sensor assembly, for example by a remote processor. The connection to the remote processor may be done wirelessly in order to avoid tampering with a physical connection (such as wires) between the sensor assembly and the processor.

The present invention may provide many potential advantages over the prior art.
A reduction in the occurrence of false alarms. The present invention provides an improved way of differentiating between ambient noise and that due to tampering with a target surface by making a comparison of the energy associated with the target surface and that associated with the ambient environment. This comparison is made in such a way that an alarm may only be triggered if the source of the noise is determined to be from the target surface.
The sensor assembly can be used on a variety of surfaces such as a window, door, or roof as the detection system does not depend on a particular frequency spectrum, such as that typical of breaking glass.
The sensor assembly can be constructed from relatively inexpensive components, including common audio transducers and relatively simple microprocessors, as the processing of the signals from the transducers is relatively simple in comparison to that required in some prior art systems.
The sensor assembly may be a compact, single portable device that is relatively inexpensive and which provides an improved detection system for detecting tampering with a wide variety of target surfaces.

### BRIEF DESCRIPTION OF DRAWINGS

Further aspects of the present invention will become apparent from the following description which is given by way of example only and with reference to the accompanying drawings in which:

FIG. 1 shows a sensor assembly in accordance with a preferred embodiment;

FIG. 2 shows a schematic flow diagram of a method executed within the sensor assembly;

FIG. 3 shows a graph of the energy received by an environmental transducer and a target transducer over a range of frequencies; and

FIG. 4 shows a plot of the ratio between the two transducers, comparing the case where sound is conveyed through a target material, and the case where sound is conveyed through the air.

### BEST MODES FOR CARRYING OUT THE INVENTION

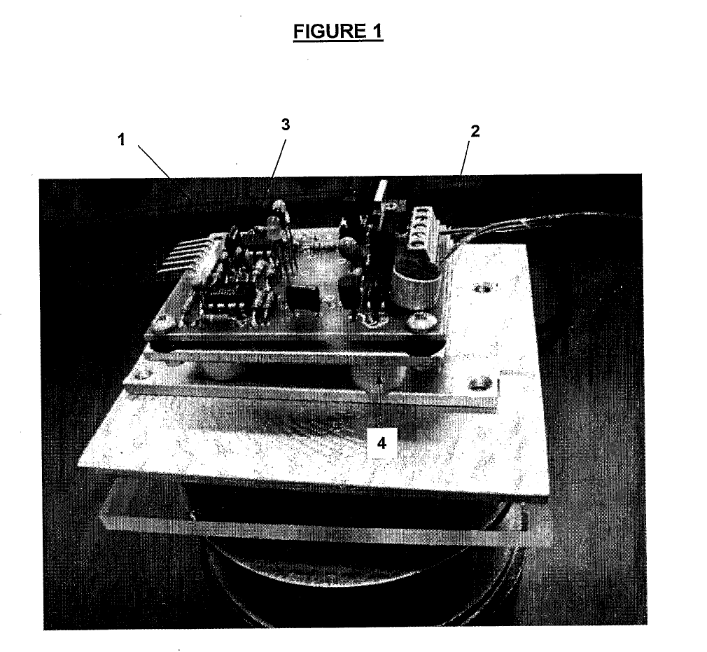

FIG. 1 shows a sensor assembly 1 according to a preferred embodiment. The sensor assembly 1 includes a target vibration transducer 3, in the form of an audio transducer, and an environmental vibration transducer 2, also in the form of an audio transducer.

The target vibration transducer 3 is attached to a first mount, in the form of a base plate 7, that is configured to acoustically couple to a target surface (not shown).

The target vibration transducer 3 is attached to the base plate 7 and configured to detect audio energy in the base plate 7. In this way when the base plate 7 is acoustically coupled to a target surface the target vibration transducer 3 detects audio energy transferred from the target surface to the base plate 7.

The target surface may be an exterior surface of a building, such as a window, window frame, door, or roof of a building, or a fence such as a security fence. This allows the sensor to detect disturbances on that surface. In practice the target surface may be any solid surface, including surfaces not on buildings, such as windows of vehicles or portions of monuments that may be tampered with or vandalised, or a surface of a wire or fence post of a fence.

The environmental vibration transducer 2 is attached to a second mount 6 and is configured to detect ambient acoustic energy in the environment surrounding the transducer.

An isolating material 4 acoustically isolates the first and second mounts from each other. The isolating material 4 preferably physically “suspends” the second mount (and environmental vibration transducer 2) on the base plate 7 (including the target vibration transducer 3) as well as acoustically isolating them. The isolating material 4 preferably has a large as possible acoustic impedance. Suitable isolating material 4 may be felt, synthetic sponge, or acoustic foam. However, any material that meets the above conditions may also be used. This means that the two transducers receive audio energy only from the intended source (solid target surface or environment), despite being physically connected.

The sensor assembly also includes a computation circuit 5 for receiving signals from the environment and target transducers and provides an alarm signal if the signals meet predetermined criteria.

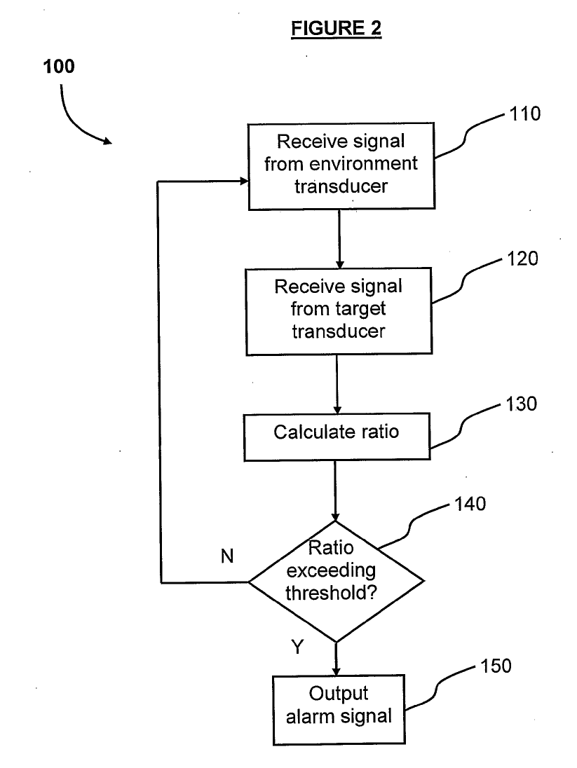

FIG. 2 shows a schematic flow diagram of a method 100 performed by the computation circuit 5 of the sensor assembly 1. More particularly, the steps of the method 100 are controlled by computer executable instructions executing within the computation circuit 5.

In step 110 the computation circuit 5 receives a signal from the environment transducer, with the signal being representative of ambient noise in the immediate surroundings of the sensor assembly 1.

In step 120 a signal from the target transducer is received by the computation circuit 5, with that signal being representative of noise associated with the surface the sensor assembly 1 is mounted on.

In step 130 the computation circuit 5 calculates a ratio of the energy of the signal from the target transducer to the energy of the signal received from the environment transducer 2. More particularly, the comparison circuit 5 computes the ratio of exponentially-weighted, time-averaged means of the absolute values of bandpass-filtered voltages from transducers 2 and 3, with the voltages being representative of the sound pressure level of the acoustic wave received by the transducers 2 and 3.

In step 140 computation circuit 5 determines whether the ratio exceeds a predetermined threshold. If it is determined in step 140 that the ratio does exceed the threshold then the alarm signal is output. Alternatively, processing returns to step 110 from where step 110 to 140 are repeated.

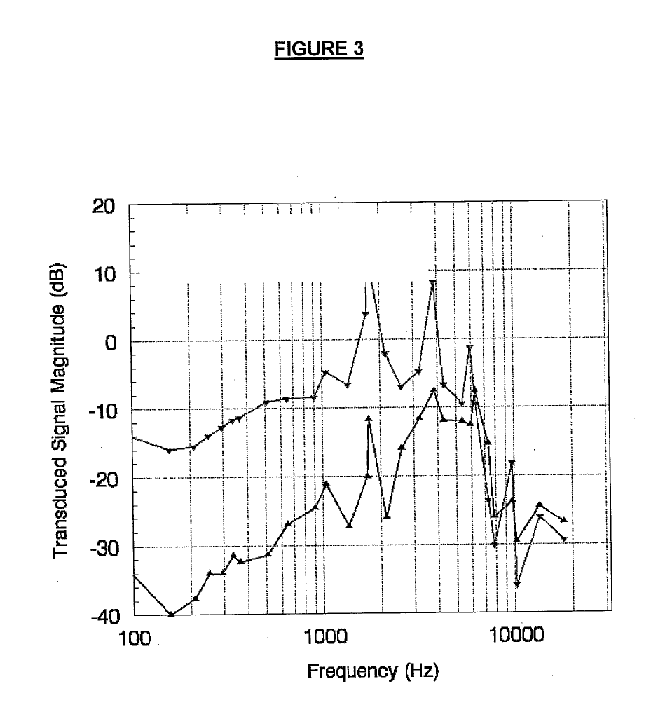

FIG. 3 shows a graph of the energies received by the environment transducer 2 and the target transducer 3 respectively over a range of frequencies.

FIG. 3 shows two lines. The upper line shows the energy of the signal, received from the target transducer 3 over a range of frequencies, and the lower of the two lines shows the energy of the signal received from the environment transducer 2 over that range of frequencies. As can be seen from this graph, the two energies follow the same pattern. The ratio of these two energies is used to activate an alarm if that ratio exceeds the threshold. For example, while the ratios are less than 2:1, any vibration may be attributed to environmental noise, whereas if the ratio goes above 2:1 then it may be inferred that there is noise directly attributed to the target.

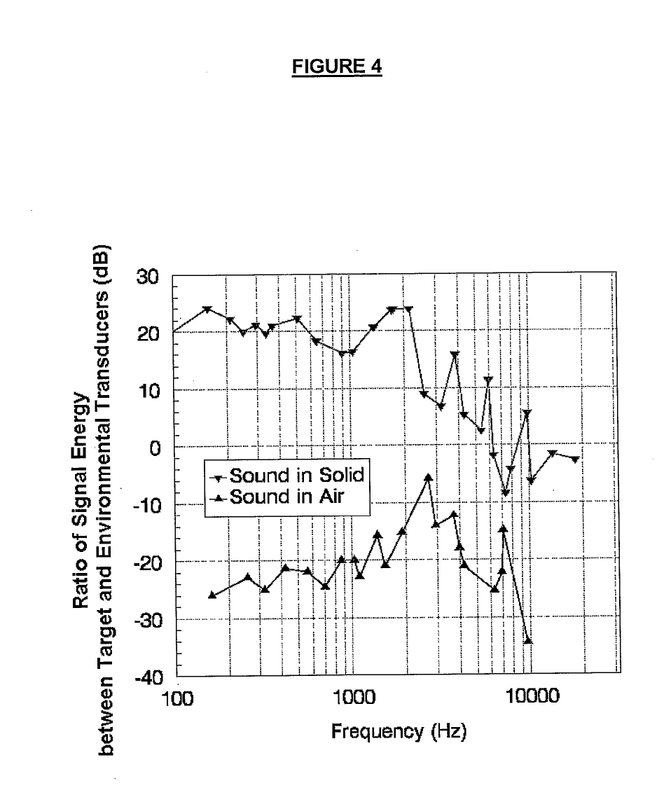

FIG. 4 shows a graph of the ratio between the two transducers for two cases: the upper line represents the case where the sound is conveyed through the material associated with the target surface, and the lower line represents the case when the sound is conveyed through the air. As can be seen from the bottom line of the graph, any sound that originated in the air (and therefore in the environment) has a lower ratio of signal energy between the two transducers than the case where the sound originates from the target surface. This allows a threshold to be easily set based on these ratios.

The graph of FIG. 4 shows the ratio for each frequency to aid the description, but the circuitry 5 does not resolve separate frequencies. The ratio computed by the circuit 5 is the ratio of the signals as described above with reference to step 130.

The present invention provides a simple sensing assembly to detect vibrational energy propagating in a surface in which the sensor is mounted. The sensor assembly provides a reference to the environment so that an alarm system is not activated unnecessarily. The sensor assembly 1 is able to be sensitive to tampering with the object to whose surface the sensor assembly 1 is attached while being resistant to false alarms set off by sudden changes in the surrounding environment. Furthermore, the processing required is a simple ratio calculation. This does not require complex processing and will allow the device to be made simply, cheaply and easily, therefore providing a further advantage over prior art identified.

The sensor assembly provided may be used as a security alarm to detect forced entry into a building, premises or vehicle. However, those skilled in the art should appreciate that the sensor assembly provided can be used in other applications and reference to its use with alarm systems only throughout the specification should in no way be seen as limiting.

For example, in the preferred implementation the computation circuit 5 calculates in step 130 the ratio of the energy of the signal from the target transducer to the energy of the signal received from the environment transducer 2. However, other comparisons may be made between the energy of the signal from the target transducer and the energy of the signal received from the environment transducer 2 before the result of the comparison is used in step 140 to determine whether to output an alarm signal. For example, an absolute value subtraction of the energy of the signal from the target transducer and the energy of the signal received from the environment transducer 2 may be used.

Aspects of the present invention have been described by way of example only and it should be appreciated that modifications and additions may be made thereto without departing from the scope thereof.

1-14. (canceled)

15. A sensor assembly for detecting vibrational energy on a target surface, comprising:
at least one target vibration transducer configured to detect vibrational energy associated with at least one target surface; and
at least one environmental vibration transducer, each environmental vibration transducer being configured to detect vibrational energy in the immediate vicinity of the environmental vibration transducer;
wherein the at least one environmental vibration transducer is vibrationally isolated from the at least one target vibration transducer.

16. The sensor assembly as claimed in claim 15, wherein the vibrational energy is audio energy.

17. The sensor assembly as claimed in claim 15 wherein each of the target and environmental vibration transducers is an audio transducer.

18. The sensor assembly as claimed in claim 15 including a processor for:
receiving signals indicating energies from the target vibration transducer and the environmental vibration transducer;
for comparing the energy from the target vibration transducer with the energy from the environmental vibration transducer; and
outputting an output signal based upon the comparison.

19. The sensor assembly as claimed in claim 18 wherein the comparison is determining a ratio of the energy from the target vibration transducer and the energy from the environmental vibration transducer.

20. The sensor assembly as claimed in claim 18, wherein the comparison is a ratio of time-averaged means of the absolute values of bandpass-filtered voltages from the target vibration transducer and the environmental vibration transducer.

21. The sensor assembly as claimed in claim 18, wherein the comparison is an absolute value subtraction of the vibrational energy received from the target vibration transducer and the environmental vibration transducer.

22. The sensor assembly as claimed in claim 15 including
at least two mounts, wherein
the target vibration transducer is attached to a first mount configured to vibrationally couple to a target surface, and
the environmental vibration transducer is attached to a second mounting means,
wherein the second mount is vibrationally isolated from the first mount.

23. A method for comparing vibrational energies including the steps of:
a) receiving vibrational energy from at least one target vibration transducer configured to measure vibrational energy associated with at least one target surface;
b) receiving vibrational energy from at least one environmental vibration transducer, each environmental transducer being configured to measure vibrational energy in the immediate surrounding of the environmental transducer;
c) comparing said vibrational energy from the target vibration transducer with the energy from the environmental vibration transducer; and
d) outputting a signal based upon the comparison;
wherein the at least one environmental transducer is vibrationally isolated from the at least one target transducer.

24. The method as claimed in claim 23, wherein the comparison is a ratio of the vibrational energy from the target vibration transducer and the vibrational energy from the environmental vibration transducer.

25. The method as claimed in claim 23 wherein the comparison is a ratio of exponentially-weighted, time-averaged means of the absolute values of bandpass-filtered voltages from the target vibration transducer and the environmental vibration transducer.

26. The method as claimed in claim 23 wherein the comparison is an absolute value subtraction of the vibrational energy from the target vibration transducer from the vibrational energy from the environmental vibration transducer.
